(19) United States
(12) Patent Application Publication
(10) Pub. No.: US 2012/0233908 A1
(43) Pub. Date: Sep. 20, 2012

(54) VOLE FEEDER SYSTEM

(76) Inventor: Kenneth C. Drake, Midway, UT (US)

(21) Appl. No.: 13/233,850

(22) Filed: Sep. 15, 2011

Related U.S. Application Data
(60) Provisional application No. 61/383,222, filed on Sep. 15, 2010.

(51) Int. Cl. A01M 25/00

(52) U.S. Cl. 43/131

(57) ABSTRACT

An exemplary system includes a feeder system configured to distribute a poisonous bait to voles and/or similar pests. One or more distribution tubes protect the bait from being absorbed, dissolved, or otherwise rendered ineffective, while continuously making the bait available to the pests. The distribution tubes also provide a tunnel-like environment such that the voles may feel comfortable enough to stay and eat. As the bait is eaten or otherwise distributed, a reserve descends to replace the previous bait. The exposed reserve tubing is attached to a removable cap, configured to allow indefinite refills of the bait until the pests are exterminated, without removal of the installed system. In some examples, the cap and reserve tubing may be decorated or camouflaged for esthetic purposes or to prevent tampering.

### RELATED APPLICATIONS

The present application claims priority under 35 U.S.C. §119(e) from the following previously-filed Provisional Patent Application, U.S. Application No. 61/383,222, filed Sep. 15, 2011, entitled “Vole Feeder System,” and which is incorporated herein by reference in its entirety.

### BACKGROUND

Voles are classified as being a member of the Cricetidae family, order of Rodentia. Voles are commonly referred to as meadow mice or field mice in North America, and are frequently confused with mice or rats. Similar to small mice, voles are considered a pest because of their high reproduction rate and the damage they can cause to vegetation by digging tunnels and eating vegetation nearby. Specifically, voles have a gestational period of twenty-one days, and can have litters between five and ten times per year. The young voles reach sexual maturity in a month. As a result of this exponential growth, vole populations can grow very large within a very short period of time. Since litters average between five and ten young, a single pregnant vole in a yard can result in a hundred or more active voles in less than a year.

Voles are destructive to lawns and gardens due to their habitat and diet. Voles burrow underground and form numerous long runs and tunnels underground. Additionally, voles thrive on a diet of primarily plants, bulbs, and roots. Such behavior and diet is very destructive to lawns and gardens.

Vole eradication typically takes the form of exterminating the voles that are damaging your landscape, repelling the voles with sound waves or with fences, and/or live removal of voles from your yard. While more humane, vole repelling and/or live removal are often unsuccessful and quite time consuming.

Effective extermination of voles often includes the use of poison baits. Poison baits are, of course, potentially hazardous to other wildlife, children and pets. If you place the poison bait directly into burrow openings, the hazard is reduced. However, there is still the potential that the poison will be extracted from the burrow opening by a child, a dog, or a cat.

### SUMMARY

A system for exterminating voles or similar pests is specifically designed to deliver poisonous bait into a tunnel created or used by the pest while reducing the likelihood of a cave-in or blockage of the bait container. The system is also designed to eliminate any danger to other animals, children, or other unintended victims.

According to one exemplary embodiment, one or more distribution tubes are fastened to a vertical reserve tube, and the top of the reserve tube capped. The reserve tube stores a reserve of the bait, which descends into the distribution tubes as bait is eaten. According to one embodiment, the distribution tubes may have a beveled end opposite the end attached to the reserve tube and may be used to penetrate underground dwellings. The beveled edge may also be oriented such that the point which is furthest from the reserve tube is oriented to be at the upper most rotation to function as an umbrella or shield to keep dirt, snow, and other debris out of the distribution tubes.

In one exemplary embodiment, the system includes at least one distribution tube with an inner radius wide enough to allow the pest to enter the distribution tube. This allows the pest to gain access to the bait, but keep the bait away from the soil where the bait may either decompose, break down, or otherwise be rendered ineffective. This environment is particularly appealing to voles, as voles prefer feel the protection of a tunnel.

According to yet another exemplary embodiment, the system is placed on the top of the ground and voles or other rodents enter the system from above the ground.

Another exemplary embodiment may include a system camouflaged to either reduce the visibility to those that would otherwise tamper with the system, and/or for aesthetic purposes. According to this embodiment, the camouflaged treatment may be any one of a one of a paint scheme, a surface finish, or an adhesive.

### BRIEF DESCRIPTION OF THE DRAWINGS

The accompanying drawings illustrate various embodiments of the principles described herein and are a part of the specification. The illustrated embodiments are merely examples and do not limit the scope of the disclosure. Throughout the drawings, identical reference numbers designate identical or similar elements.

FIG. 1 is a cross-sectional side view illustrating an exemplary vole feeder system, according to principles described herein.

FIG. 2 is a flowchart illustrating an exemplary vole feeder process, according to principles described herein.

FIG. 3 is a cross-sectional side view illustrating an exemplary vole feeder system during operation, according to one exemplary embodiment.

FIG. 4 is a cross-sectional side view illustrating the components of an exemplary vole feeder system, according to one exemplary embodiment.

### DETAILED DESCRIPTION

The present exemplary system and method reduces the vole population in a designated area by introducing a vole feeder system (100) into a flower bed, garden, or any other area where voles are present. The vole feeder system (100) uses the distribution tubes (130) to provide a tunnel like shelter where voles may feel safe while they eat poisonous bait (190). According to one exemplary embodiment, a vertical reserve tube (120) stores the bait, and dispenses the bait as needed to the distribution tubes (130). The vertical reserve (120) tube and can be accessed and refilled indefinitely. When a vole finds the system and begins eating, more bait descends from the vertical reserve tube (120) so that the vole feeder system (100) does not need to be constantly maintained and refilled. Fortunately, voles will generally exit the feeder before dying, thus leaving the distribution tubes open for other voles to eat the bait.

As described in further detail below, the exemplary system (100) described herein is an effective method of reducing/exterminating the vole population in small areas. The exemplary system (100) also incorporates a cap (140) which prevents water, snow, dirt, children, or other animals from ingesting or tampering with the bait (190).

In yet another exemplary embodiment, the vole feeder system (100) or some portion thereof includes a surface treatment configured to camouflage the vole feeder system in order to both reduce the likely hood that children or animals will find or tamper with the vole feeder system (100), especially the bait (190).

According to one exemplary embodiment, the present system (100) sits on the ground supported by the distribution tubes (130). Alternatively, the vole feeder system (100) could be partially buried, such that the entrance of the distribution tubes (130) are accessible by voles in the subterranean tunnel network, and the reserve tube (120) is accessible above ground to refill the vole feeder system (100). As voles eat the poisonous bait in the distribution tubes (130), more bait descends from the reserve tube (120), such that the bait is still available to remaining voles. Thus, the vole feeder system (100) continuously delivers poisonous bait to decrease the vole population in an incident region until extinct.

These and other uses and benefits of the systems and methods described herein will become apparent upon consideration of the following examples and the appended figures.

### Exemplary System

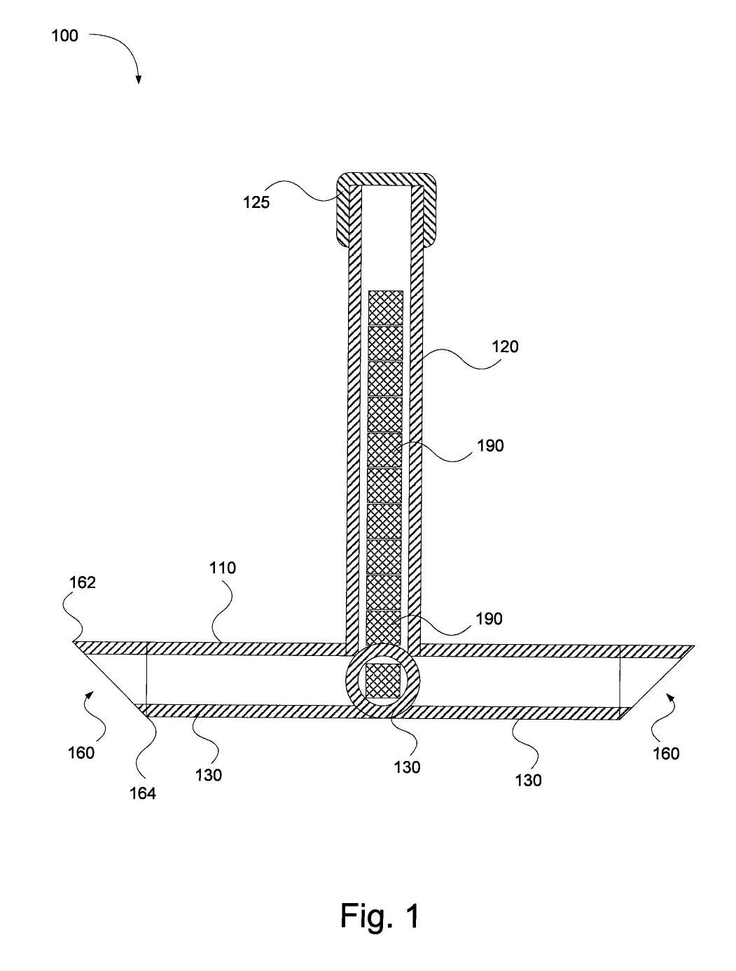

FIG. 1 illustrates a cross-sectional example of a vole feeder system, according to one exemplary embodiment. As illustrated in the exemplary system of FIG. 1, the vole feeder system (100) has one or more distribution tubes (130) connected to a reserve tube (120). The reserve tube (120) extends in a substantially vertical direction and provides easy loading of the bait (190). Finally the vole feeder system (100) may include a cap (140) which may be fastened to the top of the reserve tube (120) to keep children and other animals from accessing the bait. The cap (140) may also be fastened to the end of a vole feeder protruding from the ground. Elements and functions of the exemplary system (100) of FIG. 1 will now be described in additional detail below.

As illustrated, the present exemplary vole feeder system (100) is formed of a number of tube sections. According to one exemplary embodiment the tubes may assume any number of cross-sectional shapes. According to the exemplary embodiment illustrated in FIG. 1, the tubes making up the exemplary vole feeder system (100) have a circular cross-sectional shape. However, according to one exemplary embodiment, the tubing material (110) of the exemplary vole feeder system (100) may assume any number of cross-sectional shapes, provided that the shape presents a vole with a tunnel-type passage. The tubing material (110) used to form the exemplary vole feeder system (100) in the exemplary system may be manufactured of one or more moldable or otherwise formable materials including, but in no way limited to, aluminum, delrin, ethyl vinyl acetate monel, nylon, polyetheretherketon (PEEK), polyethylene (PE), polypropylene (PP), silicrub styrene butadiene, stainless steel, or any other substance capable of providing a tunnel-like environment for voles and distributing bait (190).

As illustrated, the exemplary vole feeder system (100) includes a reserve tube (120) configured to allow access to the system and facilitate the insertion of feed bait (190) into the vole feeder system. According to one exemplary embodiment, the reserve tube (120) holds a reserve of bait to reduce the frequency of checking and refilling the vole feeder system (100). A first end of the reserve tube (120) is coupled at a junction with the distribution tube(s) (130). A second end of the reserve tube (120) is coupled to a removable cap (140), for maintenance purposes, e.g., refilling the reserve tube with bait (190).

The reserve tube is comprised of one or more tubing materials (110) discussed above. The inner width of the reserve tube is at least wide enough to hold the bait (190), and allow the bait (190) to descend into the distribution tube(s) (130) via gravity or forced translation by a spring or other translating component.

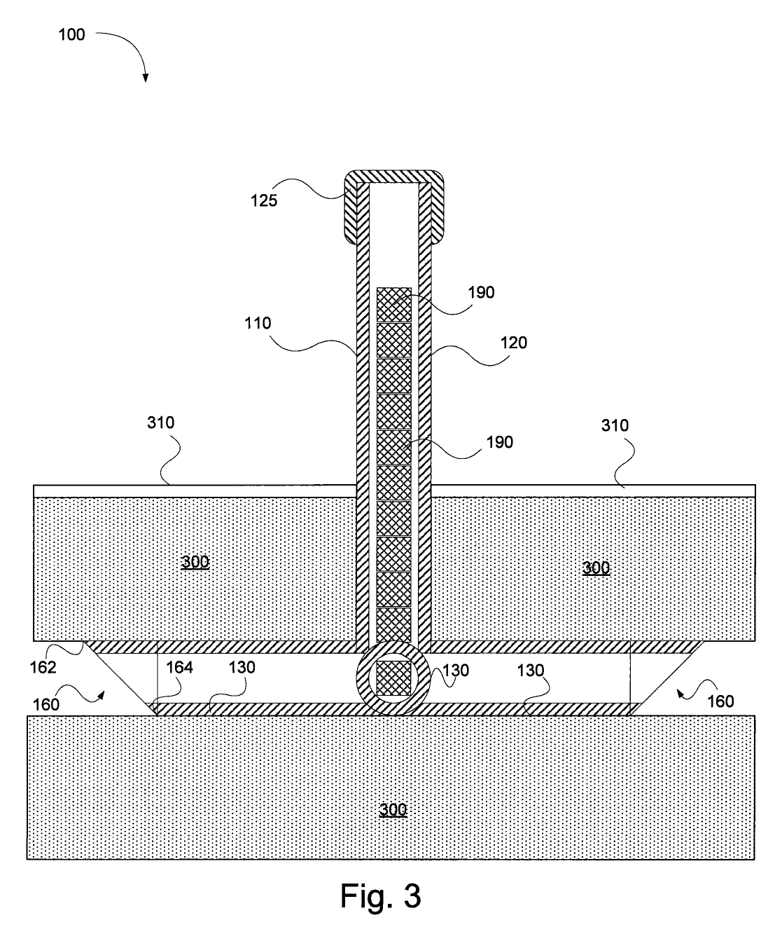

As illustrated in FIG. 3, when the exemplary vole feeder system (100) is inserted into a vole passage beneath the soil (300) and ground level (310), the reserve tube (120) extends beyond the ground level (310) to allow for access and refilling of the vole feeder system with bait (190) without removing the entire system.

Returning again to FIG. 1, the cap (125) disposed on a second end of the reserve tube (120) has two primary functions: to protect the bait (190) from being tampered with, and to protect natural persons or animals that may attempt to digest or otherwise tamper with the vole feeder system (100) or the bait (190). According to one exemplary embodiment, the cap (125) is removable such that the reserve tube (120) can be refilled, but remain fastened otherwise. The features to fasten the cap (125) to the reserve tube (120) may include, but are in no way limited to, interlocking threads, tapered ends, anti-roll, knurled, slot head/slotted head, ret ring/retaining ring, tear tab, hanger tip, pull tab, an interference fit, adhesive, a vented configuration, or any other feature that is capable of fastening the cap (125) to the reserve tube (120). Furthermore, the shape of the cap may include, but is in no way limited to, round, square, rectangular, “U” shaped, “I” shaped, or any other shape capable of fastening the cap (125) to the reserve tube (120). The cap (125) may also be manufactured of a water-resistance material including, but in no way limited to, a membrane, a polymer, and/or one or more of the tube material (110) discussed above.

Continuing with FIG. 1, the exemplary vole feeder system includes one or more distribution tubes (130) that are coupled to the first end of the reserve tube, and distribute the bait that has descended from the reserve tube (120).

As illustrated in FIG. 1, the one or more distribution tubes (130) are coupled to the reserve tube (120) on a first end, and are open on a second end to allow a vole or other animal to access the bait (190) provided through the reserve tube (120).

According to one exemplary embodiment, the distribution tubes (130) are made of the same or similar tubing material (110) discussed above, and has an inner width large enough for a vole to gain access to the bait (190).

As illustrated in FIGS. 1 and 3, the second end of the distribution tubes (130) that is open to allow access to a vole includes a bevel (160). As shown, the bevel (160) includes a forward top portion (162), and a recessed bottom portion (164). The beveled end is situated such that the point which extends the furthest faces and runs parallel to the ground but is oriented opposite from the side adjacent to the ground (310) if placed on the ground, or on the bottom of the tunnel being accessed. In this exemplary view, the edge is beveled by approximately 45 degrees, but the second end of the distribution tube(s) (130) may be beveled at any other angle which may prevent dirt, snow, rain, or any other thing from getting into the distribution tubes (130). Particularly, according to one exemplary embodiment, the incorporation of a forward top portion (162) prevents soil from caving in from the top of the vole tunnel and occupying the internal pathway of the distribution tube(s) (130), which could block access to the bait (190). Rather, any soil or water that falls upon the distribution tube(s) is passed in front of the tube and does not enter the internal pathway.

According to one exemplary embodiment, the vole feeder system (100) includes a plurality of distributor tubes coupled to the first end of the reserve tube. According to this embodiment, the plurality of distributor tubes is oriented at approximately 90 degrees to the reserve tube. According to this embodiment the distributor tubes can vertically support the reserve tube. More specifically, according to one exemplary embodiment, the vole feeder system may include at least 3 distributor tubes, wherein each of the at least 3 distributor tubes is symmetrically spaced relative to the other distributor tubes to form a supportive base system.

One or more joints may be used to couple the distribution tube(s) (130) with the reserve tube (120), including, but in no way limited to, pipe adapters, flexible couplings, ridged couplings, crosses, elbows, tees, wyes, flanges, ferrules, nipples, offsets, plugs, end bells, or any other joints that are helpful to fastening the distribution tube(s) (130) to the reserve tube (120). Furthermore, the joints, distribution tubes, and reserve tube may include features to fasten the distribution tube(s) (130) to the reserve tube (120) may include, but are in no way limited to, interlocking threads, tapered ends, anti-roll, knurled, slot head/slotted head, ret ring/retaining ring, tear tab, hanger tip, pull tab, vented, or any other feature that is helpful to fasten the distribution tube(s) (130) to the reserve tube (120).

In an anther exemplary embodiment, a distribution tube (130) may be attached to the reserve tube (120) via a “T” fitting, and placed below ground into a vole tunnel. In this use case, the beveled edge may allow for the distribution tube (130) to penetrate the subterranean tunnels easier.

As shown in FIG. 1, bait (190) is placed in the reserve tube (120) and introduced to the distribution tube(s), in order to poison a vole or other nuisance type rodent. According to one exemplary embodiment the bait (190) contains poison meant to reduce or exterminate the vole population within a local geographical area. The bait is designed to kill the voles after a period of time in order to allow the vole to leave the distribution tube (130) so that subsequent voles are able to access the bait.

According to one exemplary embodiment, the bait (190) may be manufactured of any number of rodenticides including, but in no way limited to, Zinc phosphide-based products such as ZP® Gopher Bait. Additionally, Warfin based rodenticides may be used including, but in no way limited to, D-CON® and Rodex®.

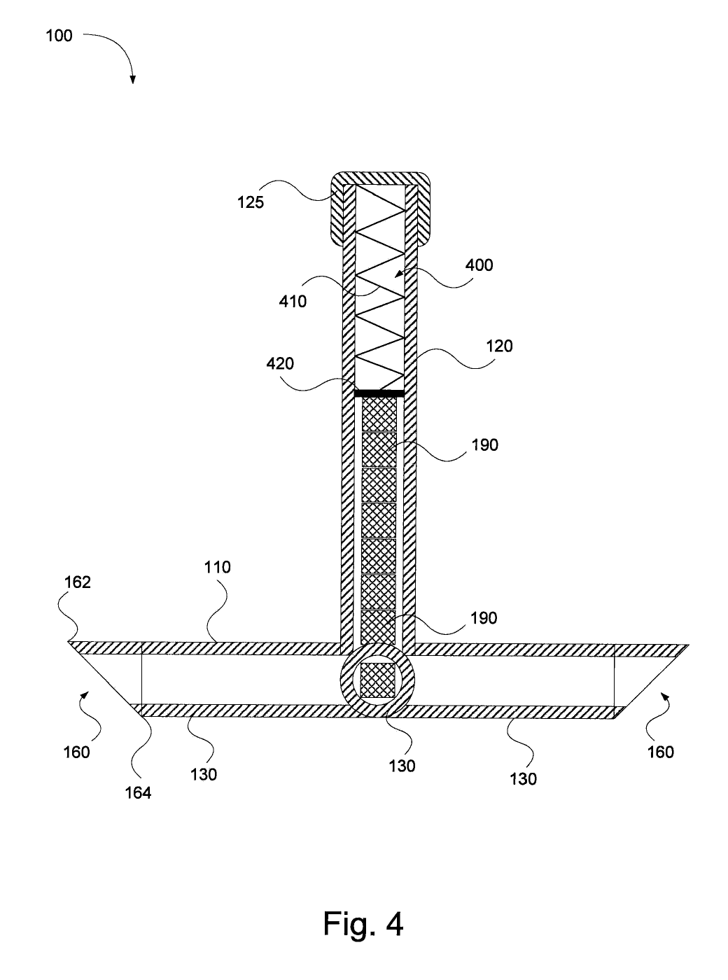

FIG. 4 also illustrates the incorporation of a biased feeding member (400) configured to impart a downward force on the bait (190) such that any frictional plug will be overcome and the bait will be allowed to descend to the distribution tube(s) (130). According to one exemplary embodiment, the biased feeding member (400) may include a plunging member (420) configured to engage and impart a downward force on the bait (190). A biased spring member (410) may then be coupled to the cap (125) on a first end and the plunging member (420) on the second side. When the cap (125) is inserted onto the reserve tube (120), the biased spring member (410) is compressed, and a downward force is then exerted onto the plunging member (420) and translated to the bait (190).

### Exemplary Process View

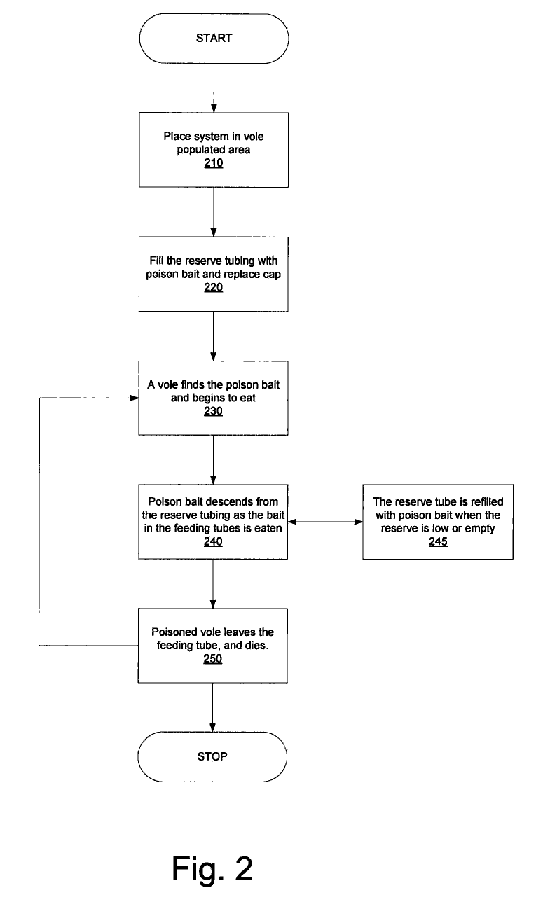

FIG. 2 illustrates an exemplary process for installation, maintenance, and operation of the vole feeder system (100), according to one exemplary embodiment. While FIG. 2 illustrates exemplary steps according to one embodiment, other embodiments may omit, add to, reorder, and/or modify any of the steps shown in FIG. 2.

As shown in FIG. 2, the system is place in a vole populated area (step 210). There are many exemplary embodiments that would suffice for installation into a vole populated area including, but not limited to, insertion of the distribution tube(s) (130) into an opening in the tunnel system, placing the system in a flower bed, garden or other populated vole area, while resting on the distribution tubes (130) and the reserve tube situated perpendicularly or vertically to the ground. Alternative embodiments could include using the beveled edge of the distribution tube(s) to penetrate the surface, or digging a hole into the tunnel system and inserting the distribution tube(s) (130) inside.

After the vole feeder system (100) has been installed, bait is placed into the reserve tube and the cap (125) is fastened to the exposed end of the reserve tube (120) (step 220). This prevents dirt and other materials from entering the vole feeder system (100) and deters people and other animals from tampering with the vole feeder system (100), or the bait inside (190).

According to one exemplary embodiment, voles will enter the distribution tube(s) (130) to begin eating the bait (190) (step 230). Other embodiments may include, but are in no way limited to a system where the distribution tubes deliver the bait, but do not require the voles to enter a distribution tube to begin eating. As the vole eats, bait descends into the distribution tubes (130) from the reserve tube (120), such that the distribution tubes (130) are continuously delivering bait (step 240) until the bait (190) in the reserve tube (120) has been depleted (step 230).

In this exemplary embodiment, upon depletion of the reserve bait (190) the reserve tube (120) is refilled (step 245), however other embodiments may include, but are in no way limited to, refilling on a regular basis such that the reserve is never depleted. In any embodiment, this step will need to be repeated throughout the use of the vole feeder system (100).

Finally, after a vole finishes eating, it will leave the distribution tube (130) to die (step 250). In this exemplary embodiment, the bait (190) does not contain poison that immediately kills the eater, instead it gives the eater time to leave the distribution tube allowing other voles to find the distribution tubes and eat (step 250).

### ALTERNATIVE EMBODIMENTS

The preceding description has been presented only to illustrate and describe embodiments of the principles described herein. It is not intended to be exhaustive or to limit the disclosure to any precise form disclosed. The principles described herein may be practiced otherwise than is specifically explained and illustrated without departing from their spirit or scope. For example, the principles described herein may be implemented in a wide variety of applications, including, but not limited to, a feeder system for controlling the population of other subterranean pests. It is intended that the scope of the invention be defined by the following claims.

What is claimed is:

1. A feeding system comprising:
at least one distributor tube having a first end and a second end;
a reserve tube having a first end and a second end, wherein said first end of said reserve tube is coupled to said first end of said at least one distributor;
a cap coupled to said second end of said reserve tube;
wherein said second end of said at least one distributor tube is beveled.

2. The feeding system of claim 1, wherein said beveled second end of said at least one distributor tube further comprises a forward top portion and a recessed bottom portion.

3. The feeding system of claim 1, further comprising a plurality of distributor tubes coupled to said first end of said reserve tube;
wherein said plurality of distributor tubes are oriented at approximately 90 degrees to said reserve tube.

4. The feeding system of claim 3, wherein said plurality of distributor tubes further comprises at least 3 distributor tubes, wherein each of said at least 3 distributor tubes is symmetrically spaced relative to the other distributor tubes.

5. The feeding system of claim 4, wherein said at least 3 distributor tubes are positioned to vertically support said reserve tube.

6. The feeding system of claim 1, further comprising a bait disposed in said reserve tube.

7. The feeding system of claim 2, wherein said beveled second end of said at least one distributor tube is beveled at an approximately 45 Degree angle.

8. The feeding system of claim 1, further comprising a biased member coupled to said cap.

9. The feeding system of claim 8, wherein said biased member coupled to said cap further comprises:
a spring member having a first end and a second end, wherein said first end of said spring member is coupled to said cap; and
a plunger member coupled to said second end of said spring member.

10. The feeding system of claim 9, wherein said plunger member is sized to freely translate in said reserve tube.

11. The feeding system of claim 1, wherein said reserve tube further comprises a camouflage surface treatment.

12. The feeding system of claim 11, wherein said camouflage surface treatment further comprises one of a paint scheme, a surface finish, or an adhesive.

13. A feeding system comprising:
at least one distributor tube having a first end and a second end;
a reserve tube having a first end and a second end, wherein said first end of said reserve tube is coupled to said first end of said at least one distributor;
a cap coupled to said second end of said reserve tube, wherein said second end of said at least one distributor tube is beveled; and
a biased member coupled to said cap.

14. The feeding system of claim 13, wherein said biased member coupled to said cap further comprises:
a spring member having a first end and a second end, wherein said first end of said spring member is coupled to said cap; and
a plunger member coupled to said second end of said spring member.

15. The feeding system of claim 14, wherein said plunger member is sized to freely translate in said reserve tube.

16. The feeding system of claim 13, wherein said reserve tube further comprises a camouflage surface treatment.

17. The feeding system of claim 16, wherein said camouflage surface treatment further comprises one of a paint scheme, a surface finish, or an adhesive.

18. The feeding system of claim 13, wherein said beveled second end of said at least one distributor tube further comprises a forward top portion and a recessed bottom portion.

19. The feeding system of claim 18, further comprising at least 3 distributor tubes coupled to said first end of said reserve tube;
wherein said at least 3 distributor tubes are oriented at approximately 90 degrees to said reserve tube, and wherein each of said at least 3 distributor tubes is symmetrically spaced relative to the other distributor tubes.

20. The feeding system of claim 13, wherein said beveled second end of said at least one distributor tube is beveled at an approximately 45 Degree angle.

21. A feeding system comprising:
at least one distributor tube having a first end and a second end;
a reserve tube having a first end and a second end, wherein said first end of said reserve tube is coupled to said first end of said at least one distributor;
a rodent bait disposed in said reserve tube;
a cap coupled to said second end of said reserve tube, wherein said second end of said at least one distributor tube is beveled and includes a forward top portion and a recessed bottom portion; and
a biased member coupled to said cap, wherein said biased member coupled to said cap further comprises:
a spring member having a first end and a second end, wherein said first end of said spring member is coupled to said cap; and
a plunger member coupled to said second end of said spring member wherein said plunger member is sized to freely translate in said reserve tube.
